(19) United States
(12) Patent Application Publication
(10) Pub. No.: US 2023/0383519 A1
(43) Pub. Date: Nov. 30, 2023

(54) CONNECTING HARDWARE AND STRUCTURE SYSTEM

(71) Applicant: Wei-Jan Lin, Alhambra, CA (US)

(72) Inventor: Wei-Jan Lin, Alhambra, CA (US)

(21) Appl. No.: 18/202,856

(22) Filed: May 26, 2023

Related U.S. Application Data
(60) Provisional application No. 63/346,305, filed on May 26, 2022.

(51) Int. Cl. E04B 1/18; E04H 3/24

(52) U.S. Cl. CPC E04B 1/185; E04H 3/24

(57) ABSTRACT

A connecting hardware, comprising: first anchoring holes, aligned on a first base line, configured for connecting to a first hardware; and arcuate slots, arranged along a plurality of parts of circumferences, respectively, configured for connecting to a second hardware, wherein the plurality of the parts of circumferences are corresponding to a common center of circle, wherein the first base line and the plurality of the parts of circumferences are on a plane.

### CROSS REFERENCE TO RELATED PATENT APPLICATION

This patent application claims priority to, and is a non-provisional patent application of, U.S. provisional patent application No. 63/346,305 filed on May 26, 2022, now pending, which is hereby incorporated by reference in its entirety.

### FIELD OF THE INVENTION

The present invention relates to a hardware for a framing structure, and more particularly, to an elbow bracket to connect one structure to another structure, and/or to connect any accessories (e.g., a camera) to a structure. Although the present invention is described as suitable for the filming industry, its concept can be used in a wide range of applications.

### BACKGROUND OF THE INVENTION

Generally, the main backbones of any lighting truss and stage truss are the trusses or the aluminum extrusion (a.k.a. pillars). When connecting a filming equipment (e.g., a camera, a light fixture) or connecting the end of an aluminum extrusion to another aluminum extrusion, it is common to use L-brackets or T-brackets.

There remains a need for a connecting hardware that allows for more precise and easy installation at a particular angle when connecting the various parts together.

There remains a need for other connecting hardware types to allow for more versatility and variability when connecting two aluminum extrusions together.

There also remains a need for a connecting hardware with minimized number of moving parts to keep manufacturing cost down.

There also remains a need for a connecting hardware with minimized number of moving parts to minimize the chances of mechanical failure during use.

There also remains a need for a method to securely and accurately mount a structure/accessory to a structure without the possibility of accidentally sliding or dislocating after assembly.

All referenced patents, applications and literatures are incorporated herein by reference in their entireties. Furthermore, where a definition or use of a term in a reference, which is incorporated by reference herein, is inconsistent or contrary to the definition of that term provided herein, the definition of that term provided herein applies and the definition of that term in the reference does not apply. The disclosed embodiments may seek to satisfy one or more of the above-mentioned needs. Although the present embodiments may obviate one or more of the above-mentioned needs, it should be understood that some aspects of the embodiments might not necessarily obviate them.

### SUMMARY OF THE INVENTION

In a general implementation, a connecting hardware is provided. The connecting hardware, comprising: first anchoring holes, aligned on a first base line, configured for connecting to a first hardware; and arcuate slots, arranged along a plurality of parts of circumferences, respectively, configured for connecting to a second hardware, wherein the plurality of the parts of circumferences are corresponding to a common center of circle, wherein the first base line and the plurality of the parts of circumferences are on a plane. The plane is referred to the surface of the drawing sheets in FIGS. 1, 3-6, and 16.

In another aspect combinable with the general implementation, in order to firmly connect to the second hardware via two connectors attached to two arcuate slots in adjacent parts of circumferences, wherein a first part of circumference among the plurality of parts of circumferences sequentially includes a second anchoring hole and a plurality of the arcuate slots, wherein a second part of circumference among the plurality of parts of circumferences sequentially includes another plurality of the arcuate slots and another second anchoring holes, wherein the first part of circumference is adjacent to the second part of circumference.

In another aspect combinable with the general implementation, in order to provide a simple design of the arcuate slots so as each of the parts of the circumferences includes identical number of arcuate slots, wherein N arcuate slots of the arcuate slots are arranged along each of the plurality of parts of circumferences, where N is a natural number.

In another aspect combinable with the general implementation, in order to provide a free channel along one of the part of circumferences, wherein a single arcuate slot of the arcuate slots is arranged along one of the plurality of parts of circumferences, wherein the single arcuate slot is arranged across the whole one of the plurality of parts of circumferences.

In another aspect combinable with the general implementation, in order to provide a simple design of the arcuate slots, wherein widths of the arcuate slots are identical.

In another aspect combinable with the general implementation, in order to let the second hardware being connected at an angle other than one of the pre-set angles, the angle is a sum of one of the pre-set angles and sliding angles, wherein a first terminal end of a first arcuate slot of the arcuate slots is aligned with a first pre-set angle, and a second terminal end of the first arcuate slot is aligned with a second pre-set angle, wherein the first pre-set angle and the second pre-set angle are two adjacent ones of a plurality of pre-set angles, wherein a difference of any two adjacent ones of the plurality of pre-set angles is identical.

In another aspect combinable with the general implementation, in order to let the second hardware being secured via two connectors via two arcuate slots in two different parts of circumferences, wherein a second terminal end of a second arcuate slot of the arcuate slots is also aligned with the first pre-set angle, wherein the first arcuate slot is arranged along a first one of the plurality of parts of circumferences and the second arcuate slot is arranged along a second one of the plurality of parts of circumferences, wherein the first one and the second one of the plurality of parts of circumferences are adjacent.

In another aspect combinable with the general implementation, in order to connect to the first hardware or a support arm of the first hardware, the connecting hardware further comprises third anchoring holes, aligned on a line which is perpendicular to the first base line, configured for connecting to the first hardware.

In another aspect combinable with the general implementation, in order to connect the first hardware at a first part of the connecting hardware, wherein one of the first anchoring holes is also on the line.

In another aspect combinable with the general implementation, in order to connect the first hardware and the second hardware in different parts of the connecting hardware, wherein the first anchoring holes and the third anchoring holes are arranged in a first part of the connecting hardware and the arcuate slots are arranged in a second part of the connecting hardware.

In another aspect combinable with the general implementation, in order to connect the first hardware and the second hardware in different parts of the connecting hardware, wherein an intersection point of the first base line and the line is not at the common center of circle.

In another aspect combinable with the general implementation, in order to connect the second hardware always via a second anchoring hole, the connecting hardware further comprises a second anchoring hole arranged at the center of circle.

In another aspect combinable with the general implementation, in order to accommodate different needs, wherein the parts of circumferences are arranged across D degrees, where D is between 10 and 360.

In another aspect combinable with the general implementation, in order to simplifies designs of support arms of the first hardware, wherein two distances between the center of circle and two nearest ones of the first anchoring holes are identical.

In another aspect combinable with the general implementation, in order to simplifies designs of three support arms of the first hardware, wherein a first distance between the center of circle and a nearest one of the third anchoring holes is identical to a second distance between the center of circle of a nearest one of first anchoring holes.

In another aspect combinable with the general implementation, in order to simplifies designs of support arms of the first hardware, two distances between the center of circle and two farthest ones of the first anchoring holes are identical.

In another aspect combinable with the general implementation, in order to simplifies designs of three support arms of the first hardware, wherein a first distance between the center of circle and a farthest one of the third anchoring holes is identical to a second distance between the center of circle of a farthest one of first anchoring holes.

In a general implementation, a structure system is provided. The structure system, comprising: the first hardware, second hardware, and the connecting hardware.

In another aspect combinable with the general implementation, in order to connect the first hardware in a direction perpendicular to the first base line as a variant of the embodiment as shown in FIG. 15, the structure system further comprises: support arms, wherein a first one of the support arms is connected through at least two of the first anchoring holes to the first hardware, wherein a second one of the support arms is connected through another two of the first anchoring holes to the first hardware.

In a general implementation, a structure system is provided. The structure system, comprising: the first hardware and the connecting hardware; and support arms, wherein a first one of the support arms is connected through at least two of the first anchoring holes to the first hardware, wherein a second one of the support arms is connected through another two of the first anchoring holes to the first hardware, wherein a third one of the support arms are is connected through at least two of the third anchoring holes to the first hardware.

The connecting hardware or the elbow bracket provides more precise and easy installation at a particular angle based on one of pre-set angles and optional sliding angles when connecting the second hardware together.

The various embodiments of the elbow brackets provide more versatility and variability when connecting the first and the second hardware (e.g., two aluminum extrusions) together.

The connecting hardware or the elbow bracket provides minimized number of moving parts to keep manufacturing cost down.

The connecting hardware or the elbow bracket provides minimized number of moving parts to minimize the chances of mechanical failure during use.

By using the connecting hardware or the elbow bracket, it is easy for securely and accurately mounting a structure/accessory (e.g., a second hardware) to a structure (e.g., a first hardware) without the possibility of accidentally sliding or dislocating after assembly.

The many specific implementation details in this disclosure should not be construed as limitations on the scope of any inventions of what may be claimed but rather as descriptions of features specific to particular implementation of particular inventions.

Certain features that are described in this specification in the context of separate implementations can also be implemented in combination in a single implementation. Conversely, various features that are described in the context of a single implementation can also be implemented in multiple implementations separately or in any suitable subcombination.

The detail of one or more implementations of the subject matter described in this disclosure are set forth in the accompanying drawings and the description below. Other features, aspects, and advantages of the subject matter will become apparent from the description, the drawings and the claims.

### BRIEF DESCRIPTION OF THE DRAWINGS

The advantages and spirit related to the present invention can be further understood via the following detailed description and drawings.

FIG. 1 is a front view of an embodiment of an elbow bracket according to an aspect of the disclosure.

FIG. 2 is a view of two elbow brackets in operation, connecting three aluminum extrusions together.

FIG. 3 is a front view of the elbow bracket of FIG. 1, illustrating 13 pre-set angled positions and various sliding positions.

FIG. 4 is a front view of another embodiment of an elbow bracket according to an aspect of the disclosure.

FIG. 5 is a front view of still another embodiment of an elbow bracket according to an aspect of the disclosure.

FIG. 6 is a front view of the elbow bracket of FIG. 5, illustrating 11 pre-set angled positions and various sliding positions.

FIG. 7 illustrates a pillar being positioned in one of the many pre-set angled positions.

FIG. 8 illustrates a pillar being positioned in another one of the many pre-set angled positions.

FIG. 9 illustrates a pillar being positioned in another one of the many pre-set angled positions.

FIG. 10 illustrates a pillar being positioned in still another one of the many pre-set angled positions.

FIG. 11 illustrates a pillar being positioned in still yet another one of the many pre-set angled positions.

FIG. 12 illustrates a pillar being positioned in one of the many sliding positions.

FIG. 13 illustrates a pillar being positioned in another one of the many sliding positions.

FIG. 14 illustrates a pillar being positioned in still another of the many sliding positions.

FIG. 15 shows another embodiment of the contemplated elbow bracket according to one aspect of the disclosure.

FIG. 16 shows the elbow bracket of FIG. 15 in a frontal view.

The following call-out list of elements in the drawing can be a useful guide when referencing the elements of the drawing figures:
1 elbow bracket
8 first anchoring hole
12 second anchoring hole
14 arcuate slot
14A arcuate slot
14B arcuate slot
14C arcuate slot
14I arcuate slot
15 first hardware
16 third anchoring hole
20 second hardware
20A second hardware
20B second hardware
30 part of circumference
51 elbow bracket
59 support arm
100 structure system
110 first base line
120 second base line
130 line
A an axial hole/a second anchoring hole
B a first/third anchoring hole
O a center of circle
S sliding angles

### DETAILED DESCRIPTION OF THE PREFERRED EMBODIMENT

Some embodiments of the present application are described in details below. However, in addition to the description given below, the present invention can be applicable to other embodiments, and the scope of the present invention is not limited by such rather by the scope of the claims. Moreover, for better understanding and clarity of the description, some components in the drawings may not necessary be drawn to scale, in which some may be exaggerated related to others, and irrelevant. If no relation of two steps is described, their execution order is not bound by the sequence as shown in the flowchart diagram.

There are many situations where equipment (e.g., a 3D camera) needs to be installed onto a pillar or any suitable structure at a precise angle. For example, for creating a three-dimensional motion picture, the angles of various equipment relative to each other and to the subjects may need to be precisely measured for calibration purposes. In one aspect of this inventive subject matter, an elbow bracket (or a connecting hardware, these two terms are interchangeable in the present invention) provides pre-set angled positions so that any equipment may be installed onto a pilar while giving the user a precise quick-and-ready measurement of the equipment's relative angle to the pillar.

In other words, the connecting hardware or the elbow bracket provided by the present invention is configured for joining another two hardware at an angle in between. In one embodiment, the angle in between the two connected hardware (e.g., pillar or equipment) may be one of many pre-set angles provided by the connecting hardware. In an alternative embodiment, the angle in between the two connected hardware may be a sum of sliding angles and one of many pre-set angles provided by the connecting hardware, where the sliding angles are smaller than an angle between any two of the pre-set angles.

The elbow bracket may be configured for connecting to a first hardware via two or more first anchoring holes which are on a first base line. Similarly, the elbow bracket may have two or more second anchoring holes which are on a second base line. In one embodiment, the first and the second base lines are in parallel. In one embodiment, at least part of the first base line is the second base line.

When the elbow bracket and the first hardware are connected via connectors (e.g., fasteners or location pins) at two or more of the first anchoring holes, the first base line is further referred as the first anchoring line. Moreover, when the elbow bracket and the second hardware are connected via two or more connectors which are aligned on a second anchoring line, an angle between the first and the second anchoring lines is the angle between the first and the second hardware.

When the first and the second anchoring lines are not in parallel, i.e., the angle between the first and the second hardware is not in parallel, the first anchoring line (i.e., the first base line) and the second anchoring line meet at a first original point in one embodiment. The elbow bracket may include an anchoring hole at the first original point. Alternatively, the second base line and the second anchoring line meet at a second original point in another embodiment. The elbow bracket may include an anchoring hole at the second original point.

The first original point may be in the middle of the first base line. Similarly, the second original point may be in the middle of the second base line. In case that at least a part of the first base line is the second base line, the first original point is at the second original point. In other words, there is only one original point.

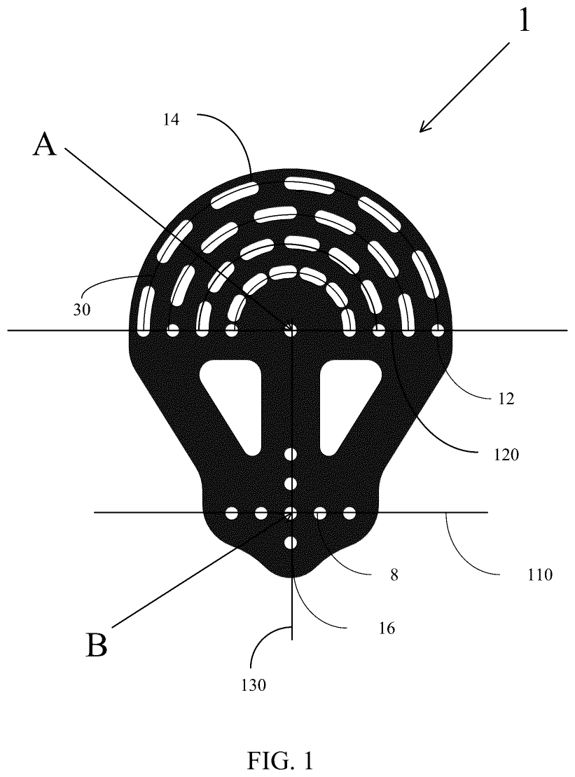

Please refer to FIG. 1, which shows a view of an elbow bracket 1 in accordance with an embodiment of the present application. The elbow bracket 1 comprises two parts for connecting two hardware, respectively. A lower part of the elbow bracket 1 comprises five first anchoring holes 8 which are on a first base line 110. In addition, there are three third anchoring holes 16 which are on a line 130 which is perpendicular to the first base line 110. There is a first anchoring hole 8 at the first original point B. The anchoring hole resides at the first original point B may be referred to the first anchoring hole 8 or the third anchoring hole 16. These first anchoring holes 8 and/or the third anchoring holes 16 are supposed to connect to a first hardware (e.g., a pillar or equipment) via connectors (unshown).

An upper part of the elbow bracket 1 comprises several second anchoring holes 12 which are on a second base line 120. The second base line 120 is in parallel to the first base line 110. An axial hole A as one of the second anchoring hole 12 which is in the middle of the second base line 120. Any second anchoring line connecting to a second hardware (e.g., a pillar or equipment) would pass through the axial/second anchoring hole A.

In one aspect combinable with the general implementation, the elbow bracket 1 can be a flat plate on a plane made of any reasonable material of sufficient strength and durability. It should be particularly noted that the elbow bracket 1 may be made of aluminum, alloys of aluminum, metal alloys, steel, stainless steel, metal, ceramic, plastics, composite materials, any natural or synthetic material, any mixture of the above materials or other materials. For example, the elbow bracket 1 may be formed by casting, drilling, CNC (computer numerical control), or other known machining methods. Additionally, the elbow bracket 1 may be surface treated by any known methods such as sandblasting, anodizing, and by any known heat treatment method such as T6 and T651. Any other combination of known surface treatments and heat treatments are particularly contemplated to strengthen any anchoring holes, threaded anchoring holes, and/or arcuate slots (or slot in short).

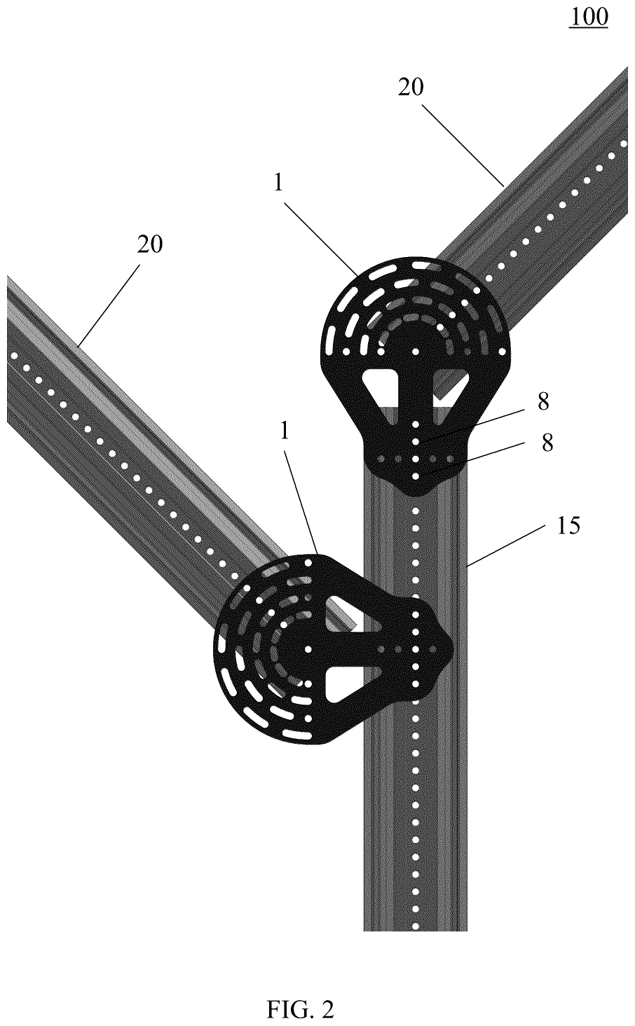

As shown in FIGS. 1 and 2, there can be several first and third anchoring holes 8 and 16 at the bottom part of the elbow bracket 1 where unshown fasteners can be used to fasten the elbow bracket onto a pillar (e.g., the first hardware). In FIG. 2, the upper elbow bracket 1 are fastened to the first hardware (e.g., a middle pillar 15) using fasteners that are fastened through the three third anchor holes 16 which are on a line 130 perpendicular to the first base line 110. Any suitable type of fastener can be used and may or may not be threaded. The lower elbow bracket 1 are fastened to the first hardware (i.e., the middle pillar 15) through the five first anchoring holes 8 which are on the first base line 110.

In the lower part of the elbow bracket 1, there can be two rows of first and third anchoring holes 8 and 16, a first row positioned at 90 degrees from the second row. These two rows 110 and 130 are intersected at the first original point which is on the first base line 110. More or less rows of anchoring holes 8 positioned at different angles to each other are also specifically contemplated. These first and third anchoring holes 8 and 16 can be threaded or unthreaded.

In the upper part of the elbow bracket 1, there may exist multiple parts of concentric circumferences 30 (or arcuate rows, or rows, these terms are interchangeable hereinafter) surrounding the second anchoring hole 12/the axial hole A, which is at the center of circles corresponding to these circumferences 30. Each part of concentric circumferences 30 may include slots 14 and/or second anchoring holes 12. As shown in FIG. 1, there are four parts of circumferences 30 in the upper part of the elbow bracket 1. However, the number of parts of circumferences 30 is not limited to 4. Preferably, the number of parts of concentric circumferences may be an even number, such as 4, 6, 8, 10 . . . This can ensure at least two connectors attaching to slots/anchoring holes of at least two adjacent circumferences can firmly fix the elbow bracket 1 to the second hardware.

In the embodiment as shown in FIG. 1, the difference between two radiuses of any two adjacent circumferences 30 is the same. However, it is not required to have equal differences between the radius of any two adjacent circumferences 30.

In the embodiment as shown in FIG. 1, widths of the arcuate slots 14 are the same for receiving fasteners with identical size. However, it is not required to have same width for each of the arcuate slots 14 because two or more different kinds of fasteners may be used in different arcuate slots 14.

In the embodiment as shown in FIG. 1, each of the part of the circumferences 30 is a half of full circle. In other words, all the part of the circumferences 30 are across 180 degrees. However, it is not required to have all the part of the circumferences 30 across same degrees.

In the embodiment as shown in FIG. 1, each of the part of circumferences 30 includes one and only second anchoring hole 12 at one end of the part of circumferences 30. The four second anchoring holes 12 are on the second base line 120. If one second anchoring hole 12 is at the right end of the corresponding circumference 30, the second anchoring hole 12 corresponding to another adjacent circumference 30 is at the left end.

In the embodiment as shown in FIG. 1, each of the part of circumferences 30 includes 6 consecutive arcuate slots 14. Each of the 6 consecutive arcuate slot 14 is arranged across slightly more than 15 degrees because the slot 14 must include spaces at both ends for accommodating connectors (e.g., fasteners). The part of circumference 30 between two consecutive arcuate slot 14 is arranged across slightly less than 15 degrees. However, it is not required to have same number of arcuate slots 14 for all part of the circumferences 30. In another embodiment, each of the part of circumferences 30 may include 9 consecutive arcuate slots 14. Each of the 9 consecutive arcuate slot 14 is arranged across slightly more than 10 degrees because the slot 14 must include spaces at both ends for accommodating connectors. The part of circumference 30 between two consecutive arcuate slot 14 is arranged across slightly less than 10 degrees.

In one embodiment, a part of circumference 30 is arranged across D degrees and there are N consecutive arcuate slots 14 and one second anchoring hole 12. Each of the N arcuate slots 14 is arranged across slightly more than (D/2N) degrees. Assuming that a connector occupies C degrees space of the arcuate slot 14, each of the arcuate slot 14 is arranged across ((D/2N)+2C) degrees. A part of the circumference 30 between two consecutive arcuate slots 14 is arranged across (D/2N)−2C degrees. Please be aware that the value of C is variable depending on how far the arcuate slot 14 is from the second original point.

In another aspect combinable with the general implementation, there can be multiple rows 30 of slots 14 arranged in a concentric (or coaxial) configuration.

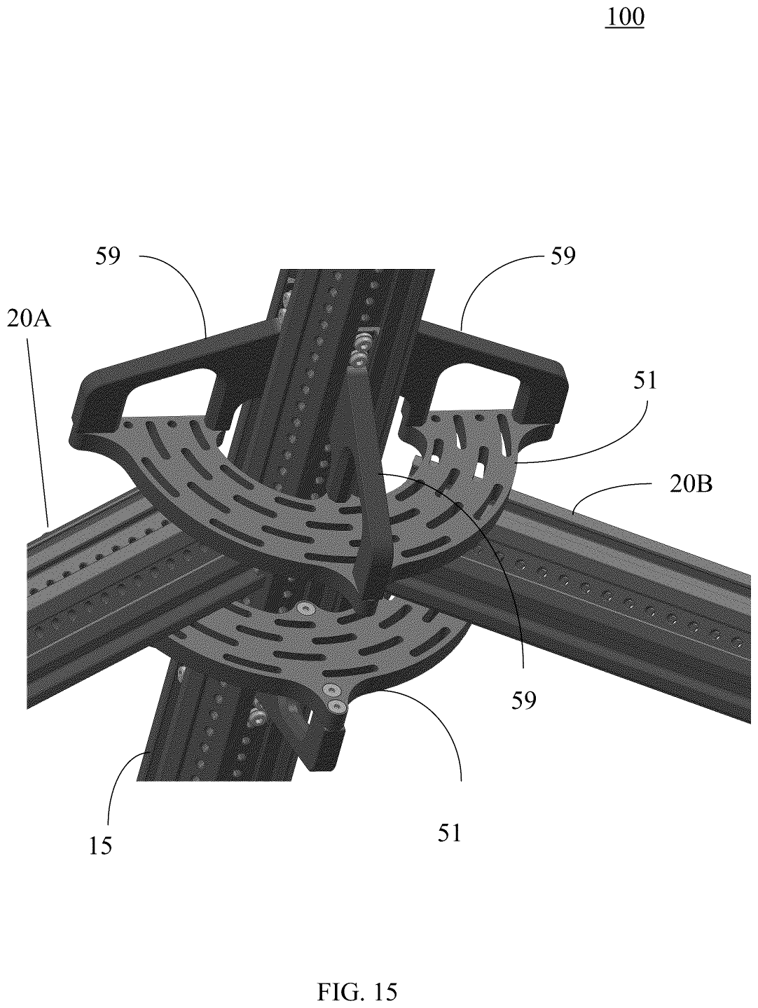

In another aspect combinable with the general implementation, there can be an axial hole A 12 at the first original point which is on the second base line 120 on the elbow bracket 1 for receiving fasteners. Alternatively, there may be embodiments (e.g., the embodiment as shown in FIG. 15) where the axial hole A 12 is not present at all.

It should be noted that in some embodiments, any of the fasteners can be replaced with location pins. Ordinary having skills in the art can understand that any known kinds of connectors such as screw, nut, fastener, and/or pin may be used via the first anchoring hole 8, the second anchoring hole 12, the third anchoring hole 16, and the arcuate slot 14 for connecting the elbow bracket 1 and another hardware may be used in the embodiments.

In another aspect combinable with the general implementation, each row 30 of slots 14 can consist of many arcuate slots 30 of varied length.

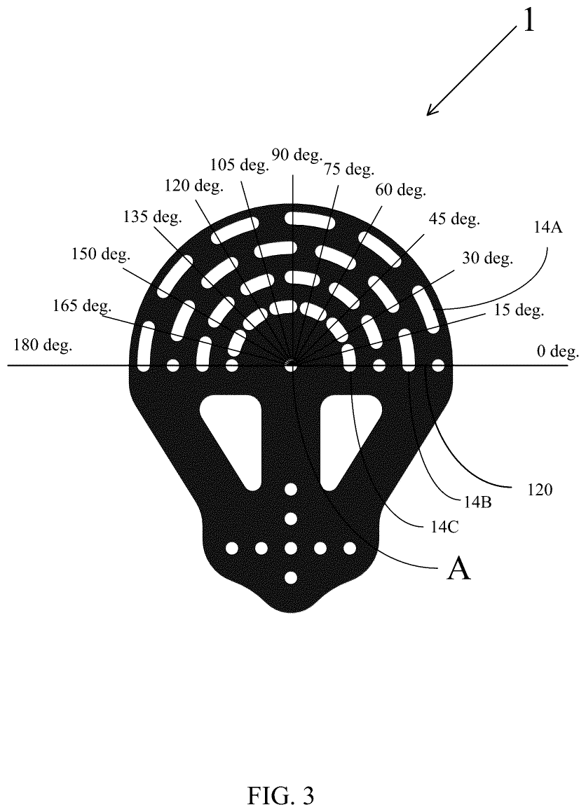

In FIG. 3, the many arcuate slots 14 of multiple rows (or part of circumferences) 30 are arranged such that the terminal ends of each arcuate slot 14 can align at a pre-set angle. These pre-set angles are based on the second base line 120 and the second original point where the axial/second anchoring hole A resides. As shown in FIG. 3, these pre-set angles are marked following the counterclockwise direction. Person having ordinary skill in the art can understand that these pre-set angles may be marked following the clockwise direction.

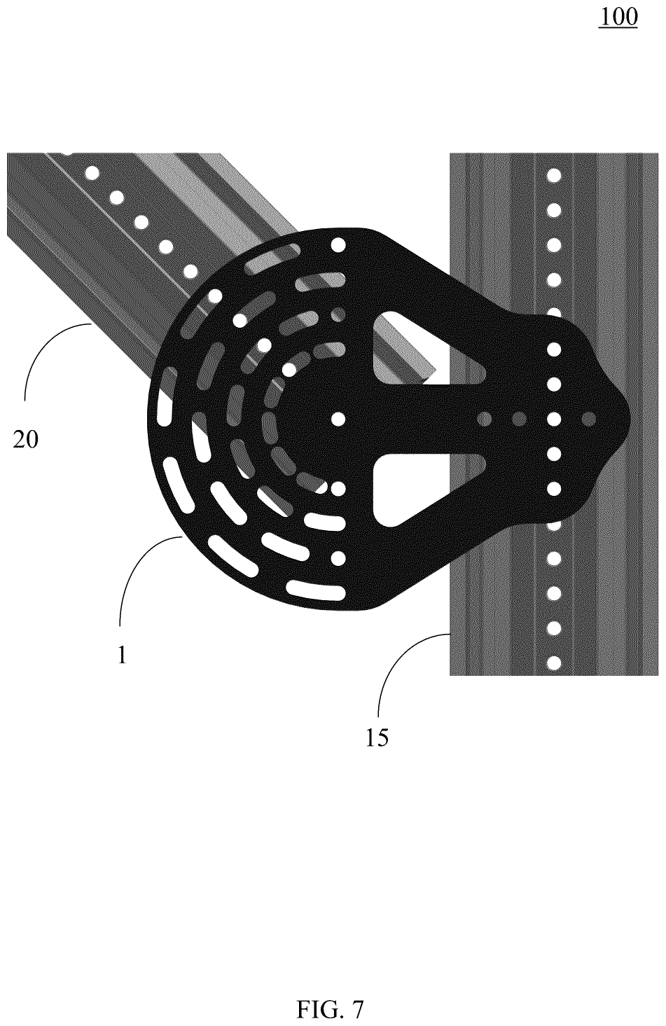

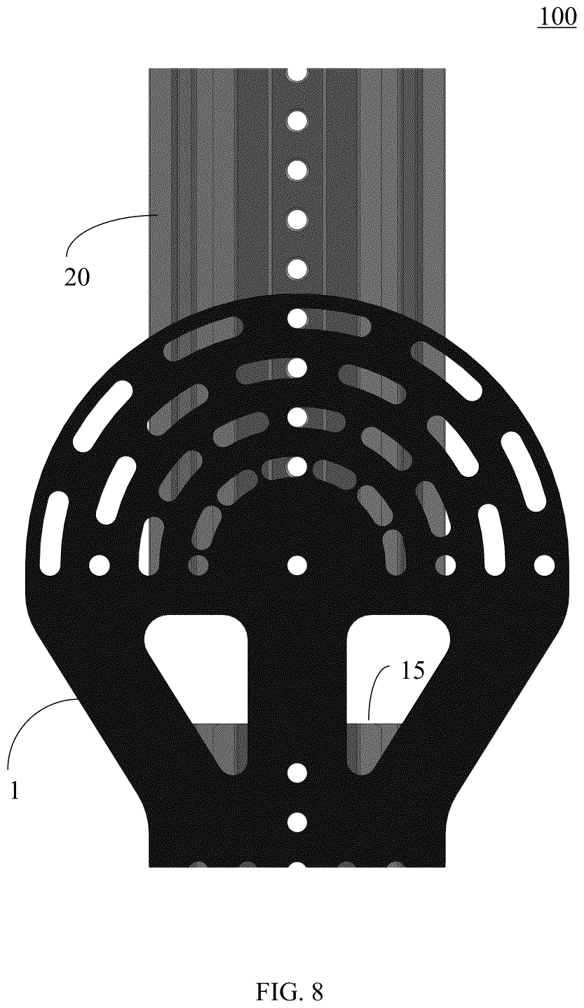

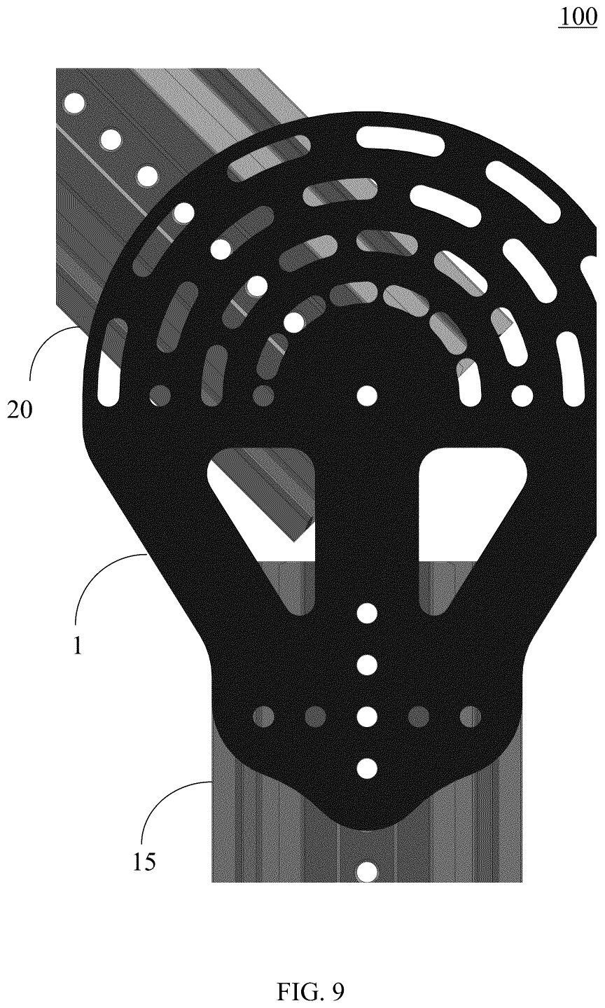

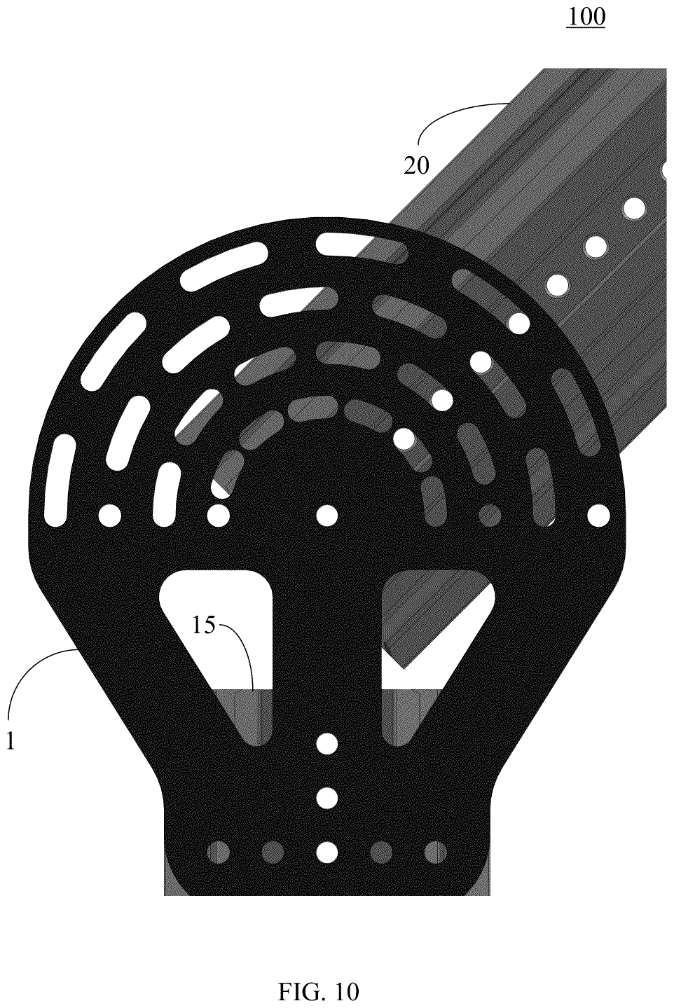

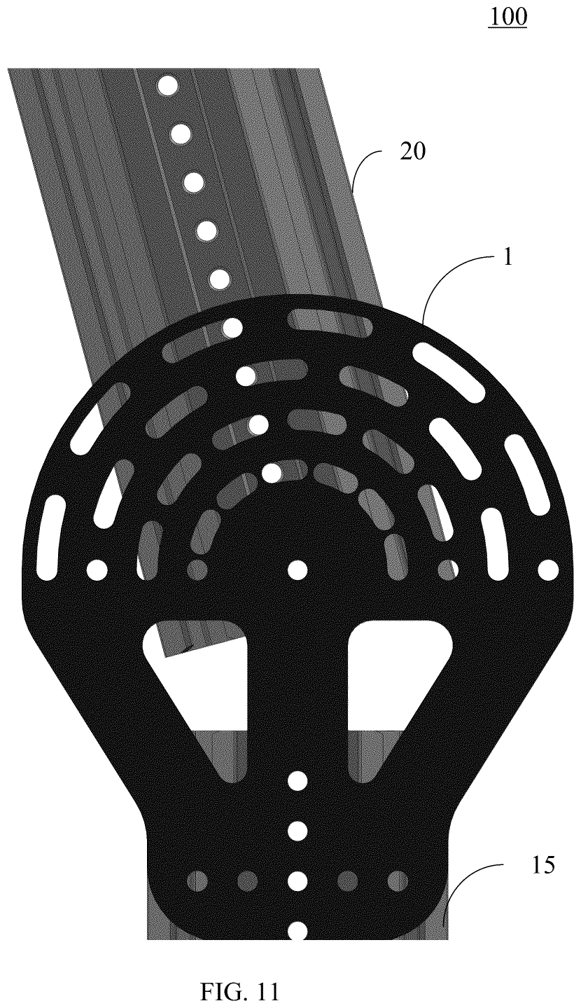

Here, at every 15-degree angle that terminal ends of the arcuate slots of the four rows of slots align. In the specific example shown in FIG. 3, if a user may use all four fasteners to reach into their respective receiving holes on the second pillar (or equipment or the second hardware 30), then the user knows the second pillar is being installed on one of the many pre-set 15-degree angles. More examples of this are shown in FIGS. 7-11. In FIGS. 7-11, the receiving holes on the second pillar are clearly matched with the terminal ends of an arcuate slot 14 in each of the four rows 30. A user may next insert four fasteners to secure the second pillar in place.

As shown in FIG. 3, the arcuate slot 14A of the outermost part of circumference has two terminal ends. The first terminal end of the arcuate slot 14A is aligned with a first pre-set angle, said 15 degrees. And the second terminal end of the arcuate slot 14A is aligned with a second pre-set angle, said 30 degrees. The difference between the first and the second pre-set angles is 15 degrees. In the embodiment as shown in FIG. 3, two terminal ends of each of the arcuate art 14 are aligned with two adjacent pre-set angles.

In other embodiments, there can be more or less rows 30 of these arcuate slots 14. For example, there can be a design where there are 6, 8, or even 10 rows 30 of arcuate slots 14. The user can choose to use however many fasteners necessary. For example, where there are four corresponding receiving holes in FIG. 3, a user may choose to use only two fasteners to get the job done. The core concept is in the arrangement of the arcuate slots to provide pre-set degree angles that a user can immediately recognize and use.

In one embodiment, the two fasteners may be applied to the first (e.g., upper) terminal end of the arcuate slot 14A and the second (e.g., lower) terminal end of the arcuate slot 14B. Alternatively, the two fasteners may be applied to the first terminal end of the arcuate slot 14A and the second terminal end of the arcuate slot 14C. In other words, in order to secure the connections, in case only two fasteners are used to align with a pre-set angle, one of them must be applied to a first terminal end of a first arcuate slot 14 and the other of them must be applied to a second terminal end of a second arcuate slot 14. One of the first and the second arcuate slots resides in an odd-numbered circumference 30 and the other of the first and the second arcuate slots resides in another even-numbered circumference 30. The odd-numbered circumference 30 and the even-numbered circumference 30 may be adjacent to each other. In such arrangement, the second hardware 20 is unable moved either way.

Similarly, in case more than two fasteners are used to align with a pre-set angle. One of them must be applied to a first terminal end of a first arcuate slot 14 and the other of them must be applied to a second terminal end of a second arcuate slot 14. One of the first and the second arcuate slots resides in an odd-numbered circumference 30 and the other of the first and the second arcuate slots resides in another even-numbered circumference 30. In such arrangement, the second hardware 20 is unable moved either way.

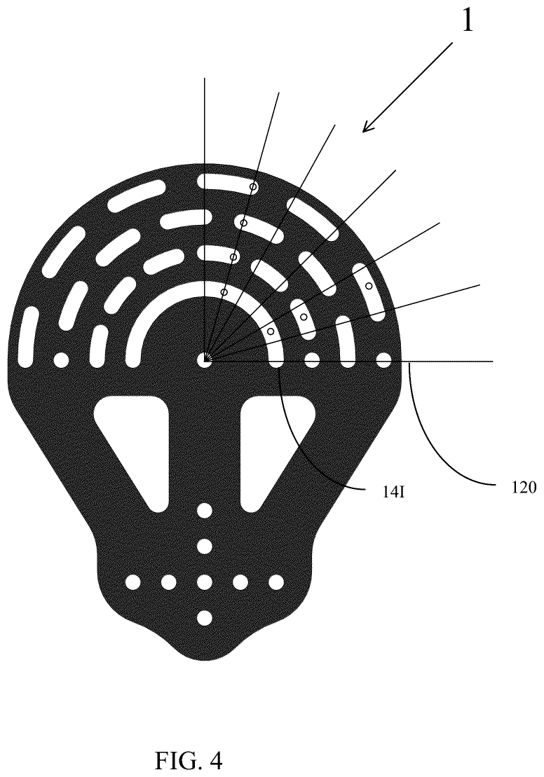

FIG. 4 shows another embodiment where the arcuate slots 14 are arranged such that the pre-set angled positions are also 15 degrees apart. Here, the difference is that the innermost row 30 of multiple arcuate slots 14 is placed with a row of a single arcuate slot 14I (a continuous free channel). The free channel or free slot 14 is arranged across the whole part of circumference/arcuate row 30. In another embodiment, this free channel can be provided on the outmost row. In yet another embodiment, this free channel can be provided somewhere between the innermost and the outermost rows.

In some embodiments, there may be two or more part of circumferences/arcuate rows 30 include single slots (or free channels) 14 across their corresponding part of circumferences 30, respectively. The number of free channels 14 is not limited to one in the embodiments.

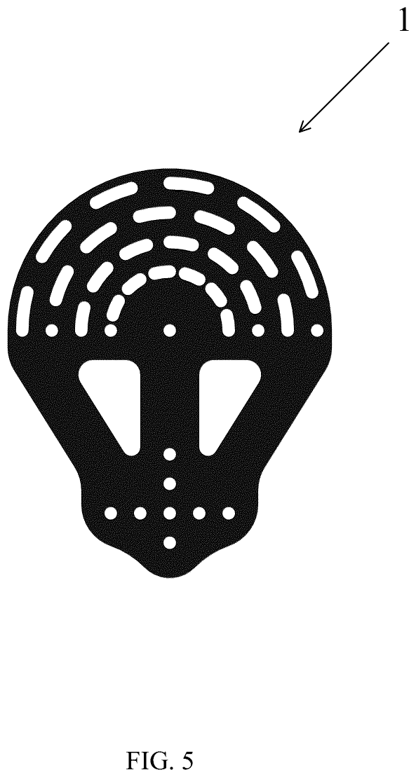

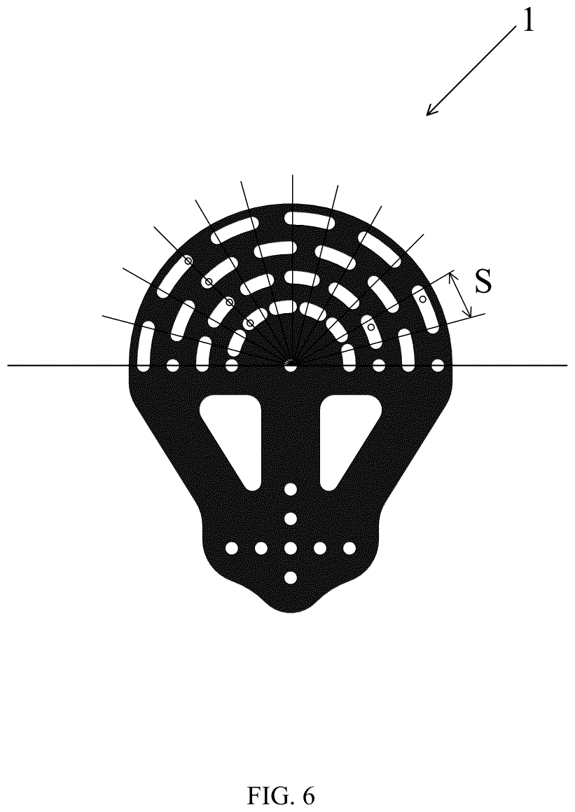

FIGS. 5 and 6 show another embodiment where the arcuate slots are arranged such that the pre-set angled positions are also at 18 degrees apart. This embodiment functions the same. Likewise, one skilled in the art would immediately recognize that other pre-set angles may be designed by rearranging the positions and lengths of the arcuate slots.

There may be situations where a user may wish to install a second pillar or another equipment 20 at an angle that is not one of the pre-set angles. This specification refers to those angles as sliding angles S. The sliding angles S are in between two adjacent pre-set angles. As shown in FIG. 6, the sliding angles S are in between two pre-set angles, i.e., 18 degrees and 36 degrees. In FIG. 6, the user may install a second pillar or equipment 20 within sliding angles S by deliberately avoiding a position where all four receiving positions can align. As shown in FIG. 6, if only two receiving positions are shown through the arcuate slots 14, the user can be rest assured that it is positioned within the sliding angles S. Similarly, as shown in FIG. 4, the innermost part of circumference 30 includes a single free channel/arcuate slot 14I. A connector applied to the free channel/arcuate slot 14I would enhance the connections provided by the other two connectors.

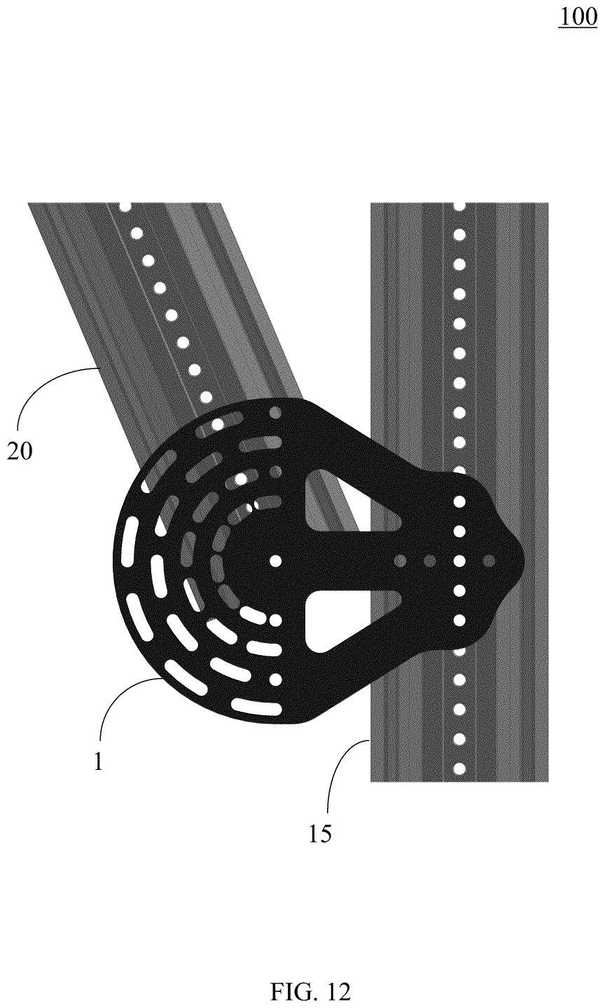

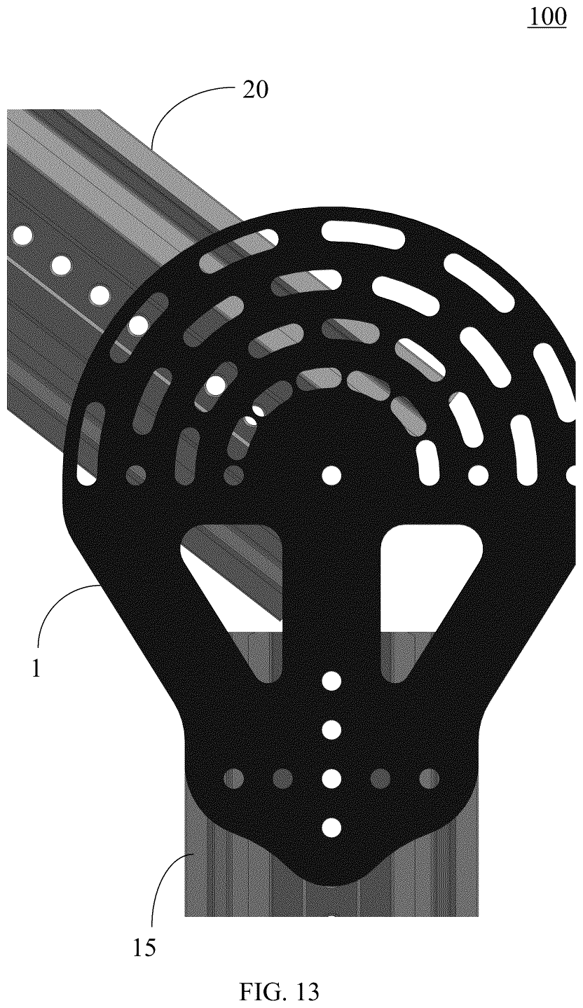

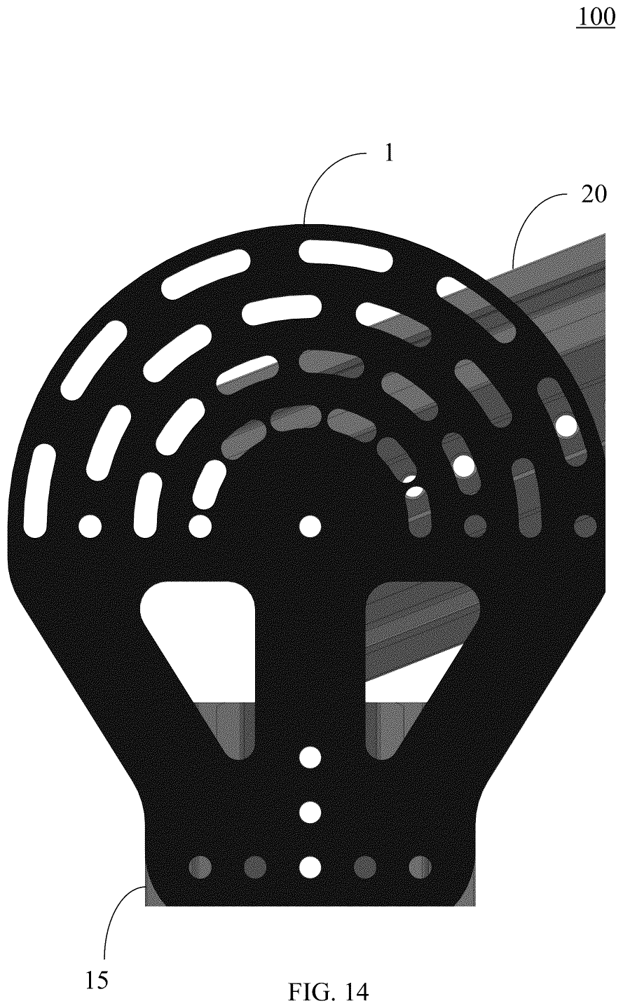

Examples of a second pillar 20 being installed within the sliding angles can be seen in FIGS. 12-14.

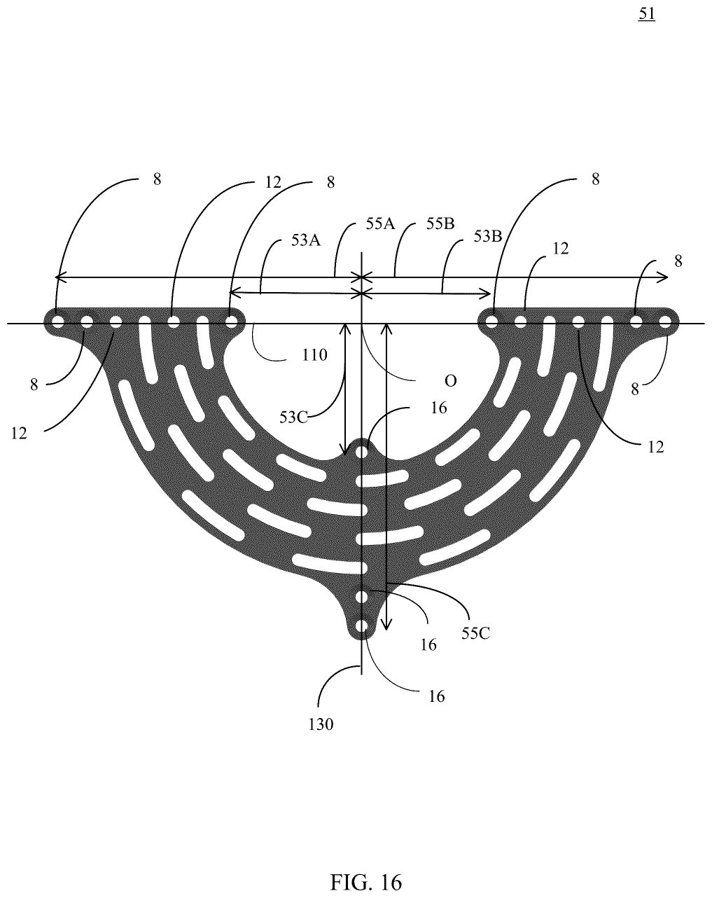

When installed, the elbow bracket 1 of a structure system 100 as shown in FIGS. 1-14 has a plane parallel to a longitudinal axis of the pillar 15 to which it is attached to FIGS. 15 and 16 illustrates another embodiment where the elbow bracket 51 has a plane perpendicular to a longitudinal axis of the pillar 15 to which it is attached to. Here, the elbow bracket 51 can be attached to the pillar 15 using support arms 59. Although FIG. 15 shows each of the elbow brackets 51 being attached to three support arms 59, just two support arms 59 can work just as well.

While the embodiment of FIGS. 1-14 shows an elbow bracket 1 of 180 degrees, and FIGS. 15-16 show an elbow bracket 51 of 180 degrees, any other degrees as little as 10 degrees and up to 360 degrees are particularly contemplated. One skilled in the art would also immediately recognize that one may use additional support arms (as many as the pillar 15 can support) as deemed necessary to provide sufficient structural integrity.

As shown in FIG. 16, the elbow bracket 51 does not include the upper part and the lower part in the embodiment as shown in FIGS. 1-14. However, the elbow bracket 51 does include six first anchoring holes 8 which are on the first base line 110 and three third anchoring holes 16 which are on the third base line 130. The three first anchoring holes 8 at the left-hand side are configured to connect a first support arm 59 of the first hardware 15. Analogously, the remaining three first anchoring holes 8 at the right-hand side are configured to connect a second support arm 59 of the first hardware 15. In addition, the three third anchoring holes 16 on the line 130 are configured to connect a third support arm 59 of the first hardware 15. Person having ordinary skill in the art can understand that it requires at least two or more anchoring holes to connect a support arm. Therefore, the elbow bracket 51 in accordance with the embodiments include four or more first anchoring holes 8 and two or more third anchoring holes 16 for connecting three support arms of the first hardware 15 respectively.

There is a gap in the first base line 110. The first base line 110 and the third line 130 intersect each other at the original point O. In the embodiment as shown in FIG. 16, a first distance 53A between the original point O and the nearest first anchoring hole 8 at the left-hand side is identical to a second distance 53B between the original point O and the nearest first anchoring hole 8 at the right-hand side. Furthermore, a third distance 53C between the original point O and the nearest third anchoring hole 16 may be identical to the first distance 53A and the second distance 53B.

Similarly, in order to have the three support arms of the first hardware 15 the same, the fourth distance 55A between the original point O and the farthest first anchoring hole 8 at the left-hand side is identical to a fifth distance 55B between the original point O and the farthest first anchoring hole 8 at the right-hand side. Furthermore, a sixth distance 55C between the original point O and the farthest third anchoring hole 16 may be identical to the fourth distance 55A and the fifth distance 55B.

Referring to FIG. 15, a cross-section of the first hardware 15 passes through the base line 110 of the elbow bracket 51. Therefore, the width of the cross-section of the first hardware 15 is smaller than the sum of the first distance 53A and the second distance 53B. The thickness of the cross-section of the first hardware 15 is smaller than the third distance 53C.

Like the elbow bracket 1, the elbow bracket 51 also include two or more parts of circumferences/arcuate rows 30. The arrangements of the parts of circumferences/arcuate rows 30 of the elbow bracket 51 are discussed above. As shown in FIG. 15, the elbow bracket 51 is configured to connecting the first hardware 15 with two second hardware 20A and 20B via the arcuate slots 14. Person having ordinary skill in the art can understand that more than two second hardware 20 can be connected via the arcuate slots 14.

In a general implementation, a connecting hardware is provided. The connecting hardware, comprising: first anchoring holes, aligned on a first base line, configured for connecting to a first hardware; and arcuate slots, arranged along a plurality of parts of circumferences, respectively, configured for connecting to a second hardware, wherein the plurality of the parts of circumferences are corresponding to a common center of circle, wherein the first base line and the plurality of the parts of circumferences are on a plane. The plane is referred to the surface of the drawing sheets in FIGS. 1, 3-6, and 16.

In another aspect combinable with the general implementation, in order to firmly connect to the second hardware via two connectors attached to two arcuate slots in adjacent parts of circumferences, wherein a first part of circumference among the plurality of parts of circumferences sequentially includes a second anchoring hole and a plurality of the arcuate slots, wherein a second part of circumference among the plurality of parts of circumferences sequentially includes another plurality of the arcuate slots and another second anchoring holes, wherein the first part of circumference is adjacent to the second part of circumference.

In another aspect combinable with the general implementation, in order to provide a simple design of the arcuate slots so as each of the parts of the circumferences includes identical number of arcuate slots, wherein N arcuate slots of the arcuate slots are arranged along each of the plurality of parts of circumferences, where N is a natural number.

In another aspect combinable with the general implementation, in order to provide a free channel along one of the part of circumferences, wherein a single arcuate slot of the arcuate slots is arranged along one of the plurality of parts of circumferences, wherein the single arcuate slot is arranged across the whole one of the plurality of parts of circumferences.

In another aspect combinable with the general implementation, in order to provide a simple design of the arcuate slots, wherein widths of the arcuate slots are identical.

In another aspect combinable with the general implementation, in order to let the second hardware being connected at an angle other than one of the pre-set angles, the angle is a sum of one of the pre-set angles and sliding angles, wherein a first terminal end of a first arcuate slot of the arcuate slots is aligned with a first pre-set angle, and a second terminal end of the first arcuate slot is aligned with a second pre-set angle, wherein the first pre-set angle and the second pre-set angle are two adjacent ones of a plurality of pre-set angles, wherein a difference of any two adjacent ones of the plurality of pre-set angles is identical.

In another aspect combinable with the general implementation, in order to let the second hardware being secured via two connectors via two arcuate slots in two different parts of circumferences, wherein a second terminal end of a second arcuate slot of the arcuate slots is also aligned with the first pre-set angle, wherein the first arcuate slot is arranged along a first one of the plurality of parts of circumferences and the second arcuate slot is arranged along a second one of the plurality of parts of circumferences, wherein the first one and the second one of the plurality of parts of circumferences are adjacent.

In another aspect combinable with the general implementation, in order to connect to the first hardware or a support arm of the first hardware, the connecting hardware further comprises third anchoring holes, aligned on a line which is perpendicular to the first base line, configured for connecting to the first hardware.

In another aspect combinable with the general implementation, in order to connect the first hardware at a first part of the connecting hardware, wherein one of the first anchoring holes is also on the line.

In another aspect combinable with the general implementation, in order to connect the first hardware and the second hardware in different parts of the connecting hardware, wherein the first anchoring holes and the third anchoring holes are arranged in a first part of the connecting hardware and the arcuate slots are arranged in a second part of the connecting hardware.

In another aspect combinable with the general implementation, in order to connect the first hardware and the second hardware in different parts of the connecting hardware, wherein an intersection point of the first base line and the line is not at the common center of circle.

In another aspect combinable with the general implementation, in order to connect the second hardware always via a second anchoring hole, the connecting hardware further comprises a second anchoring hole arranged at the center of circle.

In another aspect combinable with the general implementation, in order to accommodate different needs, wherein the parts of circumferences are arranged across D degrees, where D is between 10 and 360.

In another aspect combinable with the general implementation, in order to simplifies designs of support arms of the first hardware, wherein two distances between the center of circle and two nearest ones of the first anchoring holes are identical.

In another aspect combinable with the general implementation, in order to simplifies designs of three support arms of the first hardware, wherein a first distance between the center of circle and a nearest one of the third anchoring holes is identical to a second distance between the center of circle of a nearest one of first anchoring holes.

In another aspect combinable with the general implementation, in order to simplifies designs of support arms of the first hardware, two distances between the center of circle and two farthest ones of the first anchoring holes are identical.

In another aspect combinable with the general implementation, in order to simplifies designs of three support arms of the first hardware, wherein a first distance between the center of circle and a farthest one of the third anchoring holes is identical to a second distance between the center of circle of a farthest one of first anchoring holes.

In a general implementation, a structure system (as shown in FIGS. 2 and 7-15) is provided. The structure system, comprising: the first hardware, second hardware, and the connecting hardware.

In another aspect combinable with the general implementation, in order to connect the first hardware in a direction perpendicular to the first base line as a variant of the embodiment as shown in FIG. 15, the structure system further comprises: support arms, wherein a first one of the support arms is connected through at least two of the first anchoring holes to the first hardware, wherein a second one of the support arms is connected through another two of the first anchoring holes to the first hardware.

In a general implementation, a structure system (as shown in FIG. 15) is provided. The structure system, comprising: the first hardware and the connecting hardware; and support arms, wherein a first one of the support arms is connected through at least two of the first anchoring holes to the first hardware, wherein a second one of the support arms is connected through another two of the first anchoring holes to the first hardware, wherein a third one of the support arms are is connected through at least two of the third anchoring holes to the first hardware.

Many alternations and modifications may be made by those having ordinary skill in the art without departing from the spirit and scope of the disclosed embodiments. Therefore, it must be understood that the illustrated embodiments have been set forth only for the purposes of example and that it should not be taken as limiting the embodiments as defined by the following claims. For example, notwithstanding the face that the elements of a claim are set forth below in a certain combination, it must be expressly understood that the embodiment includes other combinations of fewer, more of different elements, which are disclosed herein even when not initially claimed in such combinations.

Thus, specific embodiments and applications of elbow bracket have been disclosed. The disclosed embodiments, therefore, are not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore obvious substitutions now or later known to one with ordinary skill in the art are defined to be within the scope of the defined elements. The claims are this to be understood to include what is specifically illustrated and described above, what it conceptually equivalent, what can be obviously substituted and also what essentially incorporates the essential idea of the embodiments. In addition, where the specification and claims refer to at least one of something selected from the group consisting of A, B, C, . . . , and N, the text should be interpreted as requiting at least one element from the group which includes N, not A plus N, or B plus N, etc.

The definitions of the words or elements of the following claims therefore include not only the combination of elements which are literally set forth but also all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can be in some cases be excised from the combination and that the claimed combination may be directed to a sub-combination or variation of a sub-combination.

What is claimed is:

1. A connecting hardware, comprising:
a first elongated arcuate slot with a first terminal end and a second terminal end in a clockwise direction, wherein said first elongated arcuate slot has a first width;
a second elongated arcuate slot with a third terminal end and a fourth terminal end in said clockwise direction, wherein said second elongated arcuate slot has said first width;
wherein said first elongated arcuate slot and said second elongated arcuate slot are concentric to a common concentric center and offset to each other;
wherein said second terminal end, said third terminal end, and said common center are aligned in a straight line with said first width; and
wherein said first terminal end and said fourth terminal end are located on different sides of said straight line.

2. The connecting hardware as claimed in claim 1, wherein said first elongated arcuate slot is on a first circumference, said first circumference includes said first elongated arcuate slot and a third elongated arcuate slot, and said first elongated arcuate slot and said third elongated arcuate slot are arranged on said first circumference at preset angles.

3. The connecting hardware as claimed in claim 2, wherein said second elongated arcuate slot is on a second circumference, said first circumference and said second circumference are concentric to said common concentric center with a first radius and a second radius, said first radius is shorter than said second radius, and said first elongated arcuate slot is shorter than said second elongated arcuate slot.

4. The connecting hardware as claimed in claim 1, wherein said common concentric center is an anchor hole.

5. The connecting hardware as claimed in claim 1, further comprising a support section;
wherein said first elongated arcuate slot and said second elongated arcuate slot are for connecting to a first hardware, and said support section is for connecting to a second hardware.

6. The connecting hardware as claimed in claim 5, wherein said support section is a support arm, and said support arm and said first elongated arcuate slot are on different planes.

7. The connecting hardware as claimed in claim 1, wherein said first elongated arcuate slot and said second elongated arcuate slot are for receiving fasteners or location pins.
